(19) United States
(12) Patent Application Publication
(10) Pub. No.: US 2018/0246034 A1
(43) Pub. Date: Aug. 30, 2018

(54) METHODS FOR CHARACTERIZING ENGINE BLOCK BORE SURFACES AND APPARATUS THEREFOR

(71) Applicant: GM GLOBAL TECHNOLOGY OPERATIONS LLC, Detroit, MI (US)

(72) Inventors: Zhe Li, Rochester, MI (US); Martin Kramer, Clarkston, MI (US); Yucong Wang, West Bloomfield, MI (US)

(73) Assignee: GM GLOBAL TECHNOLOGY OPERATIONS LLC, Detroit, MI (US)

(21) Appl. No.: 15/442,091

(22) Filed: Feb. 24, 2017

(51) Int. Cl. G01N 21/55; F02F 1/00; G01N 21/47

(52) U.S. Cl. CPC G01N 21/55; G06F 17/00; G01N 21/4738; F02F 1/004

(57) ABSTRACT

Methods for profiling a bore of an engine block are provided. Methods can comprise profiling the bore surface with a qualitative optical device (QlOD) to determine a qualitative surface characteristic map of the bore surface, wherein the QlOD comprises a light source configured to emit light toward the bore surface at an emitting angle, and a sensor array configured to sense scattered light reflected from the bore surface, and comparing the qualitative surface characteristic map to a calibration value to determine the suitability of the bore surface for thermal spray deposition. Methods can further include profiling the bore surface with a quantitative optical device (QnOD) to determine a quantitative surface characteristic, and determining a quantitative-qualitative correlation. Methods can further include profiling additional sample areas of the bore surface with the QlOD to determine a qualitative surface characteristic map of the bore surface and applying the correlation to the map.

### INTRODUCTION

During a combustion cycle of an internal combustion engine (ICE), air/fuel mixtures are provided to cylinders within an engine block of the ICE. The air/fuel mixtures are compressed and/or ignited and combusted to provide output torque via pistons positioned within the cylinders. As the pistons move within the cylinders, friction between the piston and cylinder and the presence of fuel can wear and degrade the cylinder surfaces. Additionally, combustion pressure and piston side loading can pose significant amount of stresses on the cylinder bores.

Historically. ICEs have employed cylinder liners to prevent wear or damage to the engine block. Cylinder liners can comprise thermal spray compositions, such as those comprising steel. Thermal spraying is a coating process which applies a material to a substrate by heating and optionally melting the material via combustion or an electrical plasma or arc, for example. The process is capable of rapidly applying a relatively thick coating over a large area relative to other coating processes such as electroplating, sputtering and physical and vapor deposition.

Applying a thermal spray composition to a cylinder bore requires a sufficient bore surface roughness to ensure proper adhesion between the thermal spray and the cylinder bore surface. Characterizing cylinder bore surface roughness, particularly in manufacturing environments, remains a challenge.

### SUMMARY

According to an aspect of an exemplary embodiment, a method for profiling an engine block bore surface during manufacturing is provided. The method includes profiling the bore surface with a qualitative optical device (QlOD) to determine a qualitative surface characteristic map of the bore surface, and comparing the qualitative surface characteristic map to a calibration value to determine the suitability of the bore surface for thermal spray deposition. The QlOD can include a light source configured to emit light toward the bore surface at an emitting angle, and a sensor array configured to sense scattered light reflected from the bore surface. The light source can be configured to emit light towards the bore surface at an emitting angle of between about 45 degrees to about 5 degrees. Scattered light can include light reflected from the bore surface at a scattering angle which is at least about 5 degrees greater than the emitting angle.

According to an aspect of an exemplary embodiment, a method for profiling a bore of an engine block is provided. The method can include profiling a first sample area of the bore surface with a quantitative optical device (QnOD) to determine a quantitative surface characteristic of the first sample area, profiling the first sample area with a qualitative optical device (QlOD) to determine a qualitative surface characteristic of the first sample area, comparing the quantitative surface characteristic of the first sample area with the qualitative surface characteristic of the first sample area to determine a quantitative-qualitative correlation, profiling one or more additional sample areas of the bore surface with the QlOD to determine a qualitative surface characteristic map of the bore surface, and applying the quantitative-qualitative correlation to the qualitative surface characteristic map of the bore surface to determine the suitability of the bore surface for thermal spray deposition. The QlOD can include a light source configured to emit light toward the bore surface at an emitting angle, and a sensor array configured to sense scattered light reflected from the bore surface. The sensor array of the QlOD can be capable of sensing specularly reflected light and scattered light. The qualitative surface characteristic map can include one or more qualitative surface roughness assessments, wherein each assessment is associated with a location relative to the bore surface. The light source can be configured to emit light towards the bore surface at an emitting angle of between about 15 degrees to about 5 degrees. The QnOD can be a stylus profilometer, an optical interferometer, a confocal microscope, or a structured light source (SLS) 3D camera. The first sample area can include a diameter of less than about 10 millimeters. The method can further include profiling a second sample area of the bore surface with the QnOD to determine a quantitative surface characteristic of the second sample area and profiling the second sample area with the QlOD to determine a qualitative surface characteristic of the second sample area subsequent to comparing. Comparing can further include comparing the quantitative surface characteristic of the first sample area with the qualitative surface characteristic of the first sample area and comparing the quantitative surface characteristic of the second sample area with the qualitative surface characteristic of the second sample area to determine a quantitative-qualitative correlation model.

According to an aspect of an exemplary embodiment, an apparatus for profiling the bore of an engine block is provided. The apparatus can include a body and a quantitative optical device (QnOD) and a plurality of qualitative optical devices (QlODs) disposed thereon, wherein each of the QlODs comprises a light source configured to emit light radially outward from the body and toward the bore surface at an emitting angle, and a sensor array configured to sense scattered light reflected from the bore surface. The apparatus can include a positioning element capable of adjusting the position of the measurement device within the engine block bore relative to an axial height of the bore. The apparatus can include a spacing angle of at least 90 degrees between adjacent QlODs. The QnOD can include a stylus profilometer, an optical interferometer, a confocal microscope, or a structured light source (SLS) 3D camera. The apparatus can further include a plurality of shrouds extending radially outward from the apparatus between adjacent QlODs.

Although many of the embodiments herein describe method and apparatus for profiling the surface of an engine block bore surface, particularly for use during manufacturing, the methods and apparatus provided herein are generally suitable for profiling other surfaces, and for applications beyond manufacturing. Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a side view of an engine block, according to one or more embodiments;

FIG. 2 illustrates a method for profiling an engine block bore surface, according to one or more embodiments;

FIG. 3 illustrates a schematic representation of a qualitative optical device profiling a bore surface, according to one or more embodiments;

FIG. 4 illustrates an apparatus for qualitatively assessing an engine block bore surface, according to one or more embodiments;

FIG. 5 illustrates a method for profiling a bore of an engine block, according to one or more embodiments.

FIG. 6A illustrates a specularly reflected signal strength vs. bore position from deck face data for a bore surface, according to one or more embodiments.

FIG. 6B illustrates measured Sdr of a bore surface vs. minimum failure load of a thermal spray applied to the bore surface, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This disclosure provides method and apparatus for profiling the bore surface of an engine block. In particular, the methods and apparatus disclosed herein are suitably utilized for profiling the bore surface of an engine block during manufacture, and prior to the deposition of thermal spray coatings to one or more of the bore surfaces. It has been determined that high surface roughness facilitates proper adhesion of a thermal spray to a bore surface, as evidenced by, for example, increased bond strength between the thermal spray coating and the bore surface, and reduced or eliminated delamination and/or cracking of the thermal spray coating. Profiling the bore surface prior to thermal spraying allows for the surface roughness, and accordingly subsequent bond strength, ruggedness, and durability of the coating, to be assessed. Surface texture or roughness can be defined by parameters such as average two dimensional roughness (Ra), average three dimensional roughness (Sa) and developed interfacial area ratio (Sdr), among others. Sa can be calculated using Equation (1):

Sa=∫∫ₐZ|(x,y)|dxdy (1)

Sdr, expressed as a percentage can be calculated using Equation (2) below:

$$Sdr = 100 * \frac{Sa - Cross sectional area of the surface}{Cross sectional area of the surface} \qquad ( 2 )$$

Increasing Sdr can relate linearly to increasing thermal spray adhesion strength, in some instances, wherein x, y, and z are measurements in the three orthogonal axes. It should be understood that both of these measurements are three dimensional and that the surface texture, such as textures represented by Sdr and Sa, may be thought of or considered as a fractal, that is, a surface having a never ending pattern that is self-similar at different scales. Such surface texture is believed to enhance adhesion of the thermal spray coating by providing connections between the textured surface of the substrate and the thermal spray coating at multiple dimensional sizes or scales from sub-microscopic to microscopic. For example, in one embodiment, a suitable Ra of an engine block bore can be between about 4 μm to about 25 μm. In another example, in one embodiment, a suitable Sdr of an engine block bore can be above about 100%. In another example, in one embodiment, a suitable Sa of an engine block bore can be between about 7 μm to about 18 μm, or about 9 μm to about 15 μm.

It has been determined that a surface roughness can be determined, and/or expediently profiled via qualitative profiling methods in order to determine the suitability of a surface for thermal spray deposition. Qualitative surface profiling methods and apparatus disclosed herein advantageously apply the correlation between surface roughness, thermal spray coating-bore surface bond strength and qualitative optical scattering effects to provide accurate and quick characterization methods for manufacturing applications, among others. Particularly, the methods and apparatus herein can quickly characterize the surface roughness of aluminum engine block bore surfaces and relate the same to potential bond strength between a bore surface and a thermal spray coating. In one embodiment, Sdr can be directly correlated to bond strength.

The thermal spray coating may be a steel alloy, another metal or alloy, a ceramic, or any other thermal spray material suited for the service conditions of the product (e.g., an engine block cylinder liner) and may be applied by any one of the numerous thermal spray processes such as plasma, detonation, wire arc, flame or HVOF suited to the substrate and material applied. In some embodiments, the engine block and/or bore surface comprise aluminum.

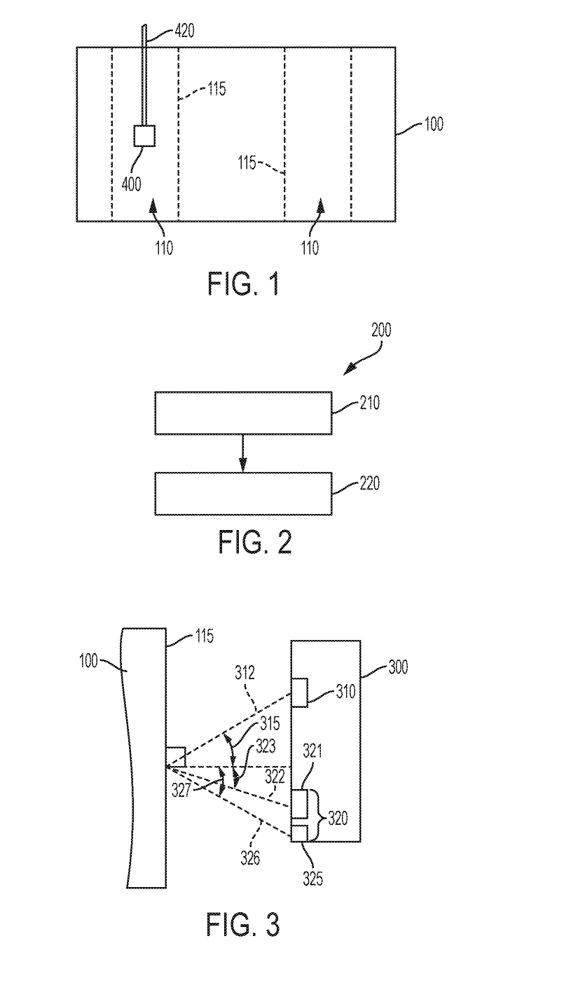

FIG. 1 illustrates a side view of an engine block 100 comprising a plurality of bores 110, each bore 110 including a bore surface 115. Bores 110 can comprise cylinder bores, wherein pistons can move during operation of an internal combustion engine (ICE) as described above. One of skill in the art will recognize that this disclosure is germane to engine blocks having a single bore 110, and a plurality of bores 110, and bores 110 are not limited to those configured to receive pistons. Bores 110 are described as having a circular cross section by virtue of the single identified bore surface 115, however in some embodiments bores 110 can comprise cross sections of various shapes. In instances where a cross sectional bore shape (e.g., square) demands a plurality of bore surfaces, the collective bore surfaces can be considered “the bore surface 115” for the purposes of this disclosure. During manufacture of an engine block, coatings can be applied to the bore surfaces to achieve various design objectives. In particular, thermal spray coatings are often applied to bore surfaces, and require a minimum surface roughness in order to effect suitable adhesion between the coating and the bore surface. Provided herein are methods and apparatus for profiling the surface roughness of a cylinder bore, such as bore surface 115. The methods are apparatus described herein are particularly suitable for profiling cylinder bores during manufacturing.

FIG. 2 illustrates a method 200 for profiling an engine block bore surface comprising profiling 210 the bore surface with a qualitative optical device (QlOD) to determine a qualitative surface characteristic map of the bore surface and comparing 220 the qualitative surface characteristic map to a calibration value to determine the suitability of the bore surface for thermal spray deposition. FIG. 3 illustrates a schematic representation of a QlOD 300 profiling a bore surface 115. As shown in FIG. 3, the QlOD 300 generally comprises a light source 310 configured to emit light 312 toward the bore surface 115 at an emitting angle 315. The emitting angle 315 can be defined as the angle at which emitted light 312 contacts the bore surface 115 relative to a normal (i.e., 90 degrees), and is identical to the angle of incidence between the emitted light 312 and the bore surface 115. The emitting angle 315 can be about 15 degrees to about 5 degrees, about 12.5 degrees to about 7.5 degrees, or about 10 degrees. In some embodiments the emitting angle 315 can be about 45 degrees to about 5 degrees. The light source 310 can comprise any light source capable of emitting light. In some embodiments, light emitted by the light source 310 comprises a wavelength of between about 300 nm to about 3,000 nm. For example, in one embodiment the light source 310 can emit visible light (i.e., light with a wavelength between about 400 nm to about 750 nm). In other embodiments, the light source 310 can emit near infrared light (i.e., light with a wavelength between about 750 nm to about 3,000 nm). Light sources can included metal-vapor lasers and light emitting diodes (LEDs).

The QlOD 300 can further comprise a sensor array 320 configured to sense scattered light reflected from the bore surface 115. A smooth bore surface 115 will reflect light at an angle identical to or similar to the emitting angle 315, whereas a rough bore surface 115 (e.g., a surface with localized non-uniformities) will reflect light at an angle which deviates from the emitting angle 315. Sensor array 320 is configured to sense specularly reflected light 322 which is reflected from the bore surface 115 at a specular reflection angle 323 within about 3 degrees, within about 2 degrees, or within about 1 degree of the emitting angle 315. In some embodiments, sensor array 320 is configured to sense specularly reflected light 322 reflected from the bore surface 115 at about the emitting angle 315. Sensor array 320 is further configured to sense scattered light 326 which is reflected from the bore surface 115 at a scattering angle 327 which is at least about 5 degrees, at least about 7.5 degrees, or at least about 10 degrees greater than the emitting angle 315. In some embodiments, scattered light 326 includes light which is reflected from the bore surface 115 at a scattering angle 327 that deviates from the emitting angle 315 by at least about 5 degrees, at least about 7.5 degrees, or at least about 10 degrees. In some embodiments, sensor array 320 is further configured to sense scattered light 326 which is reflected from the bore surface 115 at a scattering angle 327 which deviates from the emitting angle 315 by at least about 5 degrees, at least about 7.5 degrees, or at least about 10. Sensor array 320 can comprise a single sensor, or a plurality of sensors, such as specular sensor 321 and scattering sensor 325. In some embodiments, sensor array 320 can comprise a plurality of specular sensors 321 and/or a plurality of scattering sensors 325. Sensor array 320 can utilize the one or more sensors to qualitatively assess the roughness of the bore surface 115 at a given sample area (i.e., the location at which the emitted light is focused on the bore surface 115). A sample area can be 7.5 mm to about 2.5 mm in diameter, in some embodiments. In one embodiment, the sample area can be about 5 mm in diameter. In some embodiments, a sample area can be less than about 10 mm, less than about 7.5 mm, less than about 5 mm, or less than about 2.5 mm in diameter.

The QlOD can profile the roughness of the bore surface 115 at a plurality of sample areas to create a qualitative surface characteristic map of the bore surface 115. A qualitative surface characteristic map comprises one or more qualitative surface roughness assessments, wherein each assessment is associated with a location relative to the bore surface 115. For example, a qualitative surface characteristic map can comprise a vector field. Accordingly, a surface characteristic map can be created for a portion of the bore surface 115 or the entire bore surface 115. In some embodiments, method 200 comprises profiling the roughness of the bore surface 115 at a plurality of sample areas simultaneously, utilizing a plurality of QlODs 300. Such methods can employ apparatus comprising a plurality of QlODs 300, such as apparatus 400 described below.

The qualitative assessment cannot define a particular quantitative feature of the bore surface 115 (e.g., average peak height). Accordingly, method 200 further comprises comparing 220 the amount of scattered light 26 detected to calibration value to determine the suitability of the bore surface 115 for thermal spray bonding. The calibration value can comprises a minimum light intensity value detected by the scattering sensor 325, wherein an increasing light intensity value relative to the calibration value indicates an increasing suitability of the bore surface 115 for thermal spray bonding. The calibration value can comprises a maximum light intensity value detected by the specular sensor 321, wherein a decreasing light intensity value relative to the calibration value indicates an increasing suitability of the bore surface 115 for thermal spray bonding. The calibration value can comprise a reflectivity curve wherein a particular quantitative surface characteristic (e.g., Sdr) or the suitability of the bore surface 115 for thermal spray bonding is defined as a function of a qualitative surface characteristic (e.g., scattered light 326 intensity detected by the scattering sensor 325.) Method 200 can be implemented during manufacturing, and allows for a bore surface 115 to be quickly assessed before thermal spray coating.

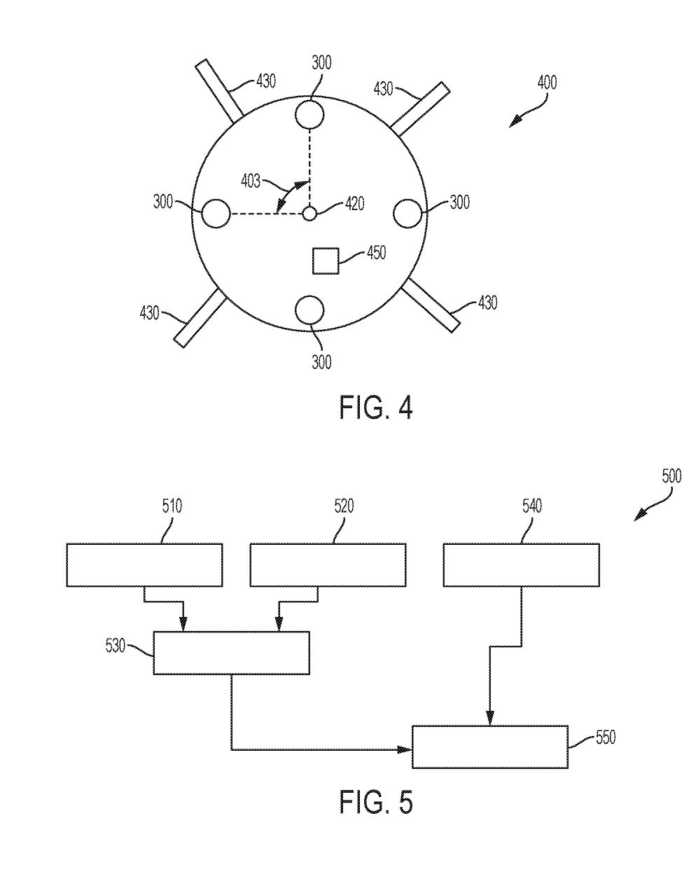

FIG. 4 illustrates an apparatus 400 suitable for qualitatively assessing an engine block bore surface. Apparatus 400 comprises a plurality of QlODs 300, as described above, disposed on or about a body 410. The plurality of QlODs 300 are positioned to emit light radially outward from the body 410. Apparatus 400 can be disposed within a bore 110, as shown in FIG. 1, in some embodiments via a positioning element 420. Positioning element 420 can comprise a rod, chain, or other like feature. In particular, positioning element 420 can be capable of adjusting the position of apparatus 400 relative an axial height 111 of the bore 110. Additionally or alternatively, positioning element 420 can be capable of rotating apparatus 400 about the central cylinder axis. In some embodiments, the positioning element 420 is capable of manipulating the position of apparatus 400 within the bore 110 such that the plurality of QlODs 300 can each profile one or more sample areas. The plurality of QlODs 300 are spaced such that light emitted from a certain QlOD 300 is not reflected off a bore surface 115 and detected by a different QlOD 300. In one embodiment, apparatus 400 comprises a spacing angle 403 of at least 90 degrees between adjacent QlODs 300. In some embodiments, apparatus 400 optionally comprises a shroud 430 between at least one pair of adjacent QlODs 300 such that light emitted from one QlOD 300 is not sensed by a sensor array from a different QlOD 300. In some embodiments, as illustrated in FIG. 4, apparatus 400 can include a shroud 430 between all adjacent QlODs 300.

In some embodiments, apparatus 400 further comprises a quantitative optical device (QnOD) 450. A QnOD 450 includes devices capable of measuring a quantitative characteristic of a surface, or providing data relating to 3-dimensional topography of a surface. A quantitative characteristic can include numerical values relating to surface qualities, such as those defined by ISO 13565-2, including reduced peak height (Spk), core roughness depth (Sk), reduced valley depth (Svk), two dimensional roughness (Ra), average three dimensional roughness (Sa) and developed interfacial area ratio (Sdr), upper limit of the core roughness (MR1), and lowest limit of the core roughness (MR2). QnODs 450 can include contact and non-contact (e.g., optical) type devices. One example of a contact QnOD 450 is a stylus profilometer, which moves a stylus or chisel disposed on a moveable arm across a sample surface. Movement of the stylus relative to the surface is translated into quantitative measurements of the latter. One example of a non-contact QnOD 450 is an optical interferometer, such as a two-beam interferometer. One example of a non-contact QnOD 450 is a confocal microscope. One example of a non-contact QnOD 450 is a structured light source (SLS) 3D camera. One of skill in the art will recognize that other QnODs not expressly disclosed herein can be suitably utilized pursuant to this disclosure.

While QnODs can provide quantitative surface profile characteristics of high precision (e.g., nanometers), such devices can be time consuming and unsuitable for use on a manufacturing scale. Accordingly, FIG. 5 illustrates a method 500 for profiling a bore of an engine block, such as bore 110 of engine block 100. Method 500 comprises profiling 510 a first sample area of the bore surface 115 with a QnOD, such as QnOD 450, to determine a quantitative surface characteristic of the first sample area, profiling 520 the first sample area with a QlOD, such as QlOD 300, to determine a qualitative surface characteristic of the first sample area, profiling 520 one or more additional sample areas of the bore surface with the QlOD, comparing 530 the quantitative surface characteristic of the first sample area with the qualitative surface characteristic of the first sample area to determine a quantitative-qualitative correlation, profiling 540 one or more additional sample areas of the bore surface with the QlOD to determine a qualitative surface characteristic map of the bore surface, and applying 550 the quantitative-qualitative correlation to the qualitative surface characteristic map of the bore surface to determine the suitability of the bore surface for thermal spray deposition. For example, a bore surface that reflects more scattered light than the first sample area indicates a higher surface texture and accordingly a surface which is more suitable for bonding than the first ample area.

In some embodiments, method 500 further comprises profiling a second sample area of the bore surface 115 with the QnOD to determine a quantitative surface characteristic of the second sample area and profiling the second sample area with the QlOD to determine a qualitative surface characteristic of the second sample area subsequent to comparing 530. In such an embodiment, comparing accordingly comprises comparing the quantitative surface characteristic of the first sample area with the qualitative surface characteristic of the first sample area and comparing the quantitative surface characteristic of the second sample area with the qualitative surface characteristic of the second sample area to determine a quantitative-qualitative correlation model. In some embodiments, the QlOD and the QnOD utilized by method 500 can be combined in a single device, such as apparatus 400. Method 500 can further utilize a plurality of QlODs, and no two qualitative surface characteristics need be measured by the same QlOD.

### Example 1

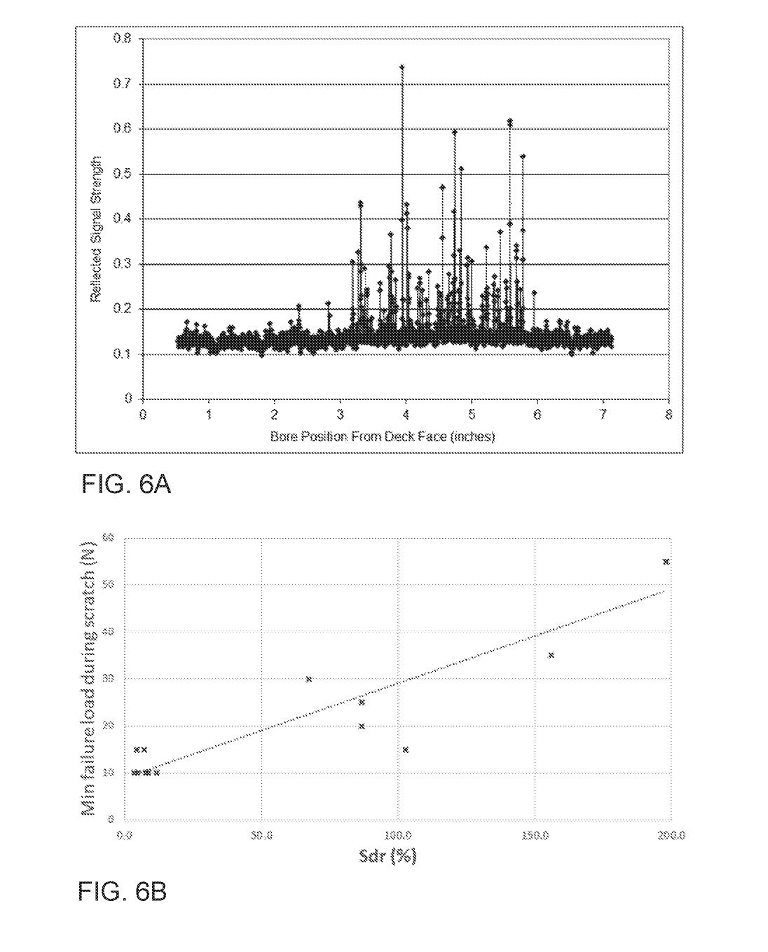

A reflectometer was used to measure reflected light from a bore surface having a rough surface (having a Sdr of greater than 50%) and a smooth surface (having a Sdr of less than about 20%). The reflectometer included a red laser light source and a specular receiver configured to detect specularly reflected light within +/−2 degrees of the angle of incidence of the laser and the bore surface. The reflectometer also included a scattered receiver configured to detect scattered light reflected from the bore surface at an angle of about 5-10 degrees greater than the angle of incidence of the laser and the bore surface. The bore surface was measured using the reflectometer, and specularly reflected signal strength relative to bore position from deck face is illustrated in FIG. 6A. The bore surface having the smooth surface is present at a bore position of about 3 inches to about 6 inches from the deck face, and reflects significantly more specular light than the rough surfaces from bore position of about 0 to 3 inches and about 6 to 7 inches from the deck face.

A thermal spray comprising one or more alloy steels (e.g., 110, 5130M, and 1080) was applied to the bore surface and removed using a scratch test to measure a minimum failure load in order to determine bond strength of the thermal spray. FIG. 6B illustrates the measure Sdr of the bore surface vs. the minimum failure load, and demonstrates a linear correlation between bond strength and Sdr.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for profiling an engine block bore surface during manufacturing, the method comprising:
profiling the bore surface with a qualitative optical device (QlOD) to determine a qualitative surface characteristic map of the bore surface, wherein the QlOD comprises a light source configured to emit light toward the bore surface at an emitting angle, and a sensor array configured to sense scattered light reflected from the bore surface; and
comparing the qualitative surface characteristic map to a calibration value to determine the suitability of the bore surface for thermal spray deposition.

2. The method of claim 1, wherein the light source is configured to emit light towards the bore surface at an emitting angle of between about 45 degrees to about 5 degrees.

3. The method of claim 1, wherein scattered light comprises light reflected from the bore surface at a scattering angle which is at least about 5 degrees greater than the emitting angle.

4. The method of claim 1, wherein the sensor array is further configured to sense specularly reflected light.

5. The method of claim 1, wherein the light source comprises a light emitting diode.

6. The method of 1, wherein the calibration value comprises a minimum scattered light intensity value at which the bore surface is suitable for thermal spray bonding.

7. A method for profiling a bore of an engine block, the method comprising:
profiling a first sample area of the bore surface with a quantitative optical device (QnOD) to determine a quantitative surface characteristic of the first sample area;
profiling the first sample area with a qualitative optical device (QlOD) to determine a qualitative surface characteristic of the first sample area, wherein the QlOD comprises a light source configured to emit light toward the bore surface at an emitting angle, and a sensor array configured to sense scattered light reflected from the bore surface;
comparing the quantitative surface characteristic of the first sample area with the qualitative surface characteristic of the first sample area to determine a quantitative-qualitative correlation;
profiling one or more additional sample areas of the bore surface with the QlOD to determine a qualitative surface characteristic map of the bore surface; and
applying the quantitative-qualitative correlation to the qualitative surface characteristic map of the bore surface to determine the suitability of the bore surface for thermal spray deposition.

8. The method of claim 7, wherein the qualitative surface characteristic comprises reduced peak height (Spk), core roughness depth (Sk), reduced valley depth (Svk), two dimensional roughness (Ra), average three dimensional roughness (Sa) and developed interfacial area ratio (Sdr), upper limit of the core roughness (MR1), and lowest limit of the core roughness (MR2).

9. The method of claim 7, wherein the sensor array of the QlOD is capable of sensing specularly reflected light and scattered light.

10. The method of claim 7, wherein the qualitative surface characteristic map comprises one or more qualitative surface roughness assessments, wherein each assessment is associated with a location relative to the bore surface.

11. The method of claim 7, wherein the light source is configured to emit light towards the bore surface at an emitting angle of between about 15 degrees to about 5 degrees.

12. The method of claim 7, wherein the QnOD is a stylus profilometer, an optical interferometer, a confocal microscope, or a structured light source (SLS) 3D camera.

13. The method of claim 7, further comprising profiling a second sample area of the bore surface with the QnOD to determine a quantitative surface characteristic of the second sample area and profiling the second sample area with the QlOD to determine a qualitative surface characteristic of the second sample area subsequent to comparing.

14. The method of claim 13, wherein comparing comprises comparing the quantitative surface characteristic of the first sample area with the qualitative surface characteristic of the first sample area and comparing the quantitative surface characteristic of the second sample area with the qualitative surface characteristic of the second sample area to determine a quantitative-qualitative correlation model.

15. The method of claim 7, wherein the first sample area comprises a diameter of less than about 10 millimeters.

16. An apparatus for profiling the bore of an engine block, the apparatus comprising
a body and a quantitative optical device (QnOD) and a plurality of qualitative optical devices (QlODs) disposed thereon, wherein each of the QlODs comprises a light source configured to emit light radially outward from the body and toward the bore surface at an emitting angle, and a sensor array configured to sense scattered light reflected from the bore surface.

17. The apparatus of claim 16, wherein the apparatus comprises a positioning element capable of adjusting the position of the measurement device within the engine block bore relative to an axial height of the bore.

18. The apparatus of claim 16, further comprising a spacing angle of at least 90 degrees between adjacent QlODs.

19. The apparatus of claim 16, wherein the QnOD is a stylus profilometer, an optical interferometer, a confocal microscope, or a structured light source (SLS) 3D camera.

20. The apparatus of claim 16, further comprising a plurality of shrouds extending radially outward from the apparatus between adjacent QlODs.
